(19) United States
(12) Patent Application Publication
(10) Pub. No.: US 2018/0003353 A1
(43) Pub. Date: Jan. 4, 2018

(54) SOLAR LIGHT WITH WIND TURBINE GENERATOR

(71) Applicant: Lazar Izradel, Tel Aviv (IL)

(72) Inventor: Lazar Izradel, Tel Aviv (IL)

(21) Appl. No.: 15/196,290

(22) Filed: Jun. 29, 2016

(51) Int. Cl. F21S 9/02; F21V 15/01; F21S 9/04; F21S 9/03; F03D 9/00; F03D 3/04; F03D 3/00; F03D 3/06; H02S 40/38; H02S 30/10; F21V 19/00; H02S 10/12; F21Y 2115/10

(52) U.S. Cl. CPC F21S 9/026; F21V 19/006; F21V 19/003; F21V 15/01; F21S 9/043; F21S 9/03; F03D 9/007; H02S 10/12; F03D 3/0436; F03D 3/005; F03D 3/062; H02S 40/38; H02S 30/10; F21Y 2115/10

(57) ABSTRACT

A solar light assembly includes an electrical mount configured for electrically mounting thereon a light device. The electrical mount is positioned underneath a first protective cover, and a wind turbine is mounted above the first protective cover and underneath a second protective cover. The wind turbine is configured to generate electrical power and is in electrical communication with the electrical mount. A solar photovoltaic panel is configured to convert solar energy to electrical energy and is in electrical communication with the electrical mount.

### FIELD OF THE INVENTION

The present invention relates generally to solar light assemblies, such as for but not limited to, a garden lamp or street lamp, and particularly to a solar light with a wind turbine generator.

### BACKGROUND OF THE INVENTION

Outdoor solar lights are known, such as for streets or gardens. They generally consist of one or more solar modules, electrical storage means for storing electrical energy connected to the solar module and one or more bulbs that are illuminated by solar power. The solar light assembly may be mounted on a pole or hung from a hook or other fixture.

A problem with such prior art solar lights is operation when there is a lack of sunlight, such as rainy days and nights. Electricity must be stored in other manners.

### SUMMARY OF THE INVENTION

The present invention seeks to provide a solar light assembly with a wind turbine generator, as is described more in detail hereinbelow.

The invention solves a problem of the limitation of solar panel energy, such as when there is no available sun (e.g., weak rays, shadows, nighttime, rainy or cloudy days) or when there are limitations where to mount solar panels and lights. The combination of a wind turbine with solar panels provides greater energy output and backup in such cases, and can recharge the rechargeable batteries used in the system. The system can thus provide a long duration of light, even during nighttime and rainy periods.

There is thus provided in accordance with an embodiment of the present invention a solar light assembly including an electrical mount configured for electrically mounting thereon a light device, the electrical mount being positioned underneath a first protective cover, a wind turbine mounted above the first protective cover and underneath a second protective cover, the wind turbine being configured to generate electrical power and in electrical communication with the electrical mount, and a solar photovoltaic panel configured to convert solar energy to electrical energy and in electrical communication with the electrical mount.

In accordance with an embodiment of the present invention the wind turbine includes vanes arranged to rotate about a vertical axis defined between the first and second protective covers, the vanes being exposed to wind that flows between the first and second protective covers. The vertical axis may be a central axis of at least one of (or both of) the first and second protective covers.

In accordance with an embodiment of the present invention the first protective cover has a larger perimeter than the second protective cover.

In accordance with an embodiment of the present invention the solar photovoltaic panel is located on at least one of (or both of) the first and second protective covers.

In accordance with an embodiment of the present invention the first and second protective covers share a common central axis.

In accordance with an embodiment of the present invention there is more than one wind turbine mounted above the first protective cover and underneath the second protective cover, the wind turbines being configured to generate electrical power and in electrical communication with the electrical mount.

In accordance with an embodiment of the present invention the solar light assembly further includes electrical storage means for storing electrical energy and connected to at least one of the wind turbine and the solar photovoltaic panel, for providing electrical energy to the electrical mount.

### BRIEF DESCRIPTION OF THE DRAWINGS

The present invention will be understood and appreciated more fully from the following detailed description taken in conjunction with the drawings in which:

FIG. 1 is a simplified front view illustration of a solar light assembly, constructed and operative in accordance with a non-limiting embodiment of the present invention; and

FIGS. 2-4 are simplified perspective illustrations of the solar light assembly.

### DETAILED DESCRIPTION OF EMBODIMENTS

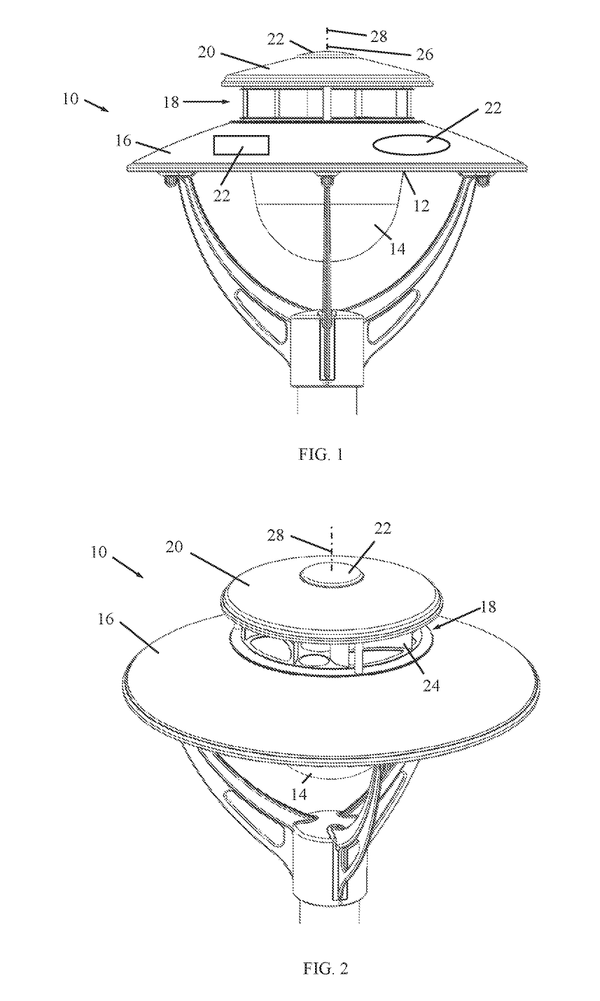

Reference is now made to FIGS. 1-4, which illustrate a solar light assembly 10, constructed and operative in accordance with a non-limiting embodiment of the present invention.

Solar light assembly 10 includes an electrical mount 12 configured for electrically mounting thereon a light device 14. The electrical mount 12 may be, without limitation, a socket for screwing therein a light bulb or an electrical contact on a printed circuit board for an LED. The light device 14 may be housed in a protective dome and may be of any color, size and light rating. The electrical mount 12 is positioned underneath a first protective cover 16.

One or more wind turbines 18 may be mounted above the first protective cover 16 and underneath a second protective cover 20. Wind turbine 18 is configured to generate electrical power and is in electrical communication with electrical mount 12.

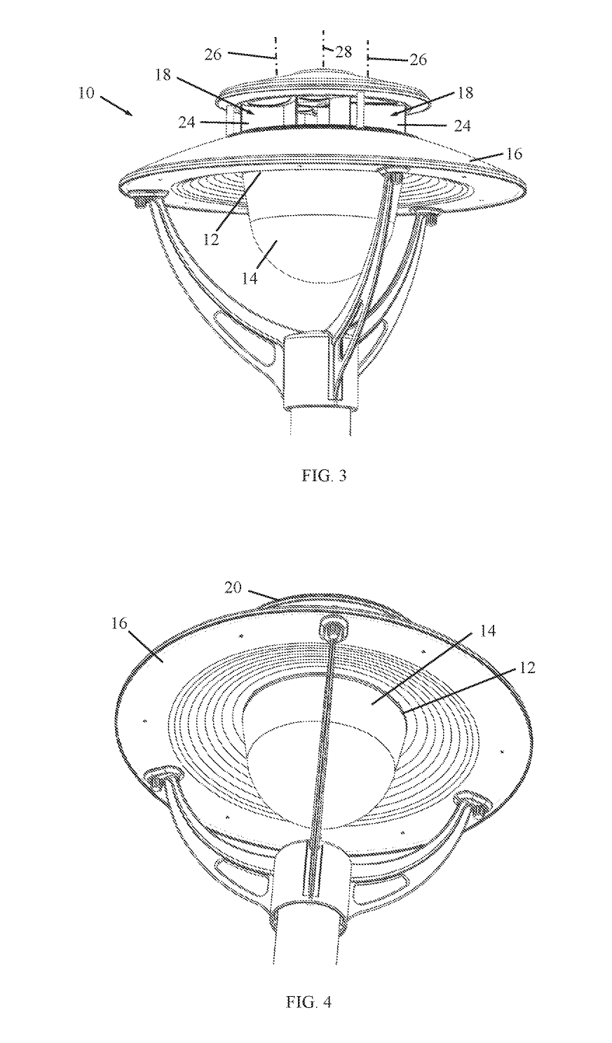

One or more solar photovoltaic panels 22 are configured to convert solar energy to electrical energy and are in electrical communication with electrical mount 12. For example, solar photovoltaic panel 22 may be located on first protective cover 16, or alternatively or additionally, or second protective cover 20. The solar photovoltaic panel 22 may be of any size and shape and may be curved to match the contour of the protective cover 16 and/or 20 (some shapes are shown in FIG. 2).

Wind turbine 18 may include vanes 24 arranged to rotate about a vertical axis 26 defined between the first and second protective covers 16 and 20. Vanes 24 are exposed to wind that flows between the first and second protective covers 16 and 20. Vertical axis 26 may be a central axis of first protective cover 16, or alternatively or additionally, of second protective cover 20. As seen in FIG. 3, more than one wind turbine 18 may be provided, in which case, each of the vertical axes 26 are off-center from the central axes 28 of the covers 16 and 20. The first and second protective covers 16 and 20 may share a common central axis 28; alternatively, the covers may have different central axes. The first and second protective covers 16 and 20 not only have the advantage of protecting the wind turbine 18 from weather elements, they also provide an enhanced flow path for air to drive vanes 24. Any air flow directed towards the surfaces of the covers is re-directed towards the vanes, thereby increasing the amount of air that impinges on the vanes 24.

In accordance with an embodiment of the present invention the first (lower) protective cover 16 has a larger perimeter than the second (upper) protective cover 20. The covers are shown as round but may be of different shapes, such as but not limited to, square, polygonal or irregular.

In accordance with an embodiment of the present invention the solar light assembly 10 further includes electrical storage means 30 for storing electrical energy, such as but not limited to, a lithium ion or nickel metal hydride battery with control circuitry. The electrical storage means 30 is connected to wind turbine(s) 18 and/or solar photovoltaic panel(s) 22, for providing electrical energy to electrical mount 12. A regulator (e.g., diode circuitry) may be provided so that power produced by wind turbine(s) 18 generator does not overload the electrical storage means 30 (such as in the case of prolonged high winds).

The different parts of the assembly may be made of plastic (such as without limitation, polycarbonate, or any other suitable engineering plastic), metal (such as without limitation, aluminum, stainless steel, or any other suitable metal), and others.

1. A solar light assembly comprising:
an electrical mount configured for electrically mounting thereon a light device, said electrical mount being positioned underneath a first protective cover;
more than one wind turbine mounted above said first protective cover and underneath a second protective cover, said wind turbine, being configured to generate electrical power and in electrical communication with said electrical mount; and
a solar photovoltaic panel configured to convert solar energy to electrical energy and in electrical communication with said electrical mount;
wherein each of said wind turbines comprises vanes arranged to rotate about a vertical axis defined between said first and second protective covers, said vanes being exposed to wind lhat flows between said first and second protective covers, and each of the vertical axes are off-center from central axes of said first and second protective covers.

2-4. (canceled)

5. The solar light assembly according to claim 1, wherein said first protective cover has a larger perimeter than said second protective cover.

6. The solar light assembly according to claim 1, wherein said solar photovoltaic panel is located on at least one of said first and second protective covers.

7. The solar light assembly according to claim 1, wherein said solar photovoltaic panel is located on both of said first and second protective covers.

8. The solar light assembly according to claim 1, wherein said first and second protective covers share a common central axis.

9. (canceled)

10. The solar light assembly according to claim 1, further comprising electrical storage means for storing electrical energy and connected to at least one of said wind turbine and said solar photovoltaic panel, for providing electrical energy to said electrical mount.

11. A solar light assembly comprising:
an electrical mount configured for electrically mounting thereon a light device, said electrical mount being positioned underneath a first protective cover;
a wind turbine mounted above said first protective cover and underneath a second protective cover, said wind turbine being configured to generate electrical power and in electrical communication with said electrical mount; and
a solar photovoltaic panel configured to convert solar energy to electrical energy and in electrical communication with said electrical mount;
and wherein said first and second protective covers have different central axes.
